(19) United States
(12) Patent Application Publication
(10) Pub. No.: US 2015/0213383 A1
(43) Pub. Date: Jul. 30, 2015

(54) Methods and Apparatus for Production Resource Management for Customized Products

(71) Applicants: Joel Lawrence Bush, Austin, TX (US); Jeffery Douglas Sewell, Austin, TX (US); Omar Besim Hakim, Austin, TX (US)

(72) Inventors: Joel Lawrence Bush, Austin, TX (US); Jeffery Douglas Sewell, Austin, TX (US); Omar Besim Hakim, Austin, TX (US)

(21) Appl. No.: 14/603,122

(22) Filed: Jan. 22, 2015

Related U.S. Application Data
(60) Provisional application No. 61/931,320, filed on Jan. 24, 2014.

(51) Int. Cl. G06Q 10/06

(52) U.S. Cl. CPC G06Q 10/06312; G06Q 10/06316

(57) ABSTRACT

Methods and apparatus for coordinating production of an item by dynamically assigning production resources. In some embodiments, responsive to receiving from a customer an item request, a method includes deconstructing the item request from the customer into a plurality of order components, constructing a tentative assignment of the order components to a plurality of production resources. In some embodiments, the method includes communicating to the customer an estimate of a set of transaction satisfaction conditions derived from the tentative assignment. In some embodiments, the method includes, responsive to acceptance of the transaction satisfaction conditions, distributing the order components to the plurality of production resources.

### CLAIM OF PRIORITY TO PROVISIONAL APPLICATION

This application claims benefit of priority of U.S. Provisional Application Ser. No. 61/931,320 entitled “Methods and Apparatus for Production Resource Management for Customized Products” filed Jan. 24, 2014, the content of which is incorporated by reference herein in its entirety and for all purposes.

### BACKGROUND

### Description of the Related Art

Electronic commerce, colloquially known as e-commerce or e-business, includes the buying and selling of products or services over electronic systems such as the Internet and other computer networks. While a significant percentage of the growth in e-commerce in recent years has involved virtual goods and services, most electronic commerce still involves fulfillment of an order through the transportation of physical items in some way. In the majority of e-commerce transactions, the purchase transaction is ordered or agreed electronically and interactively in real-time and subsequently completed with the delivery of a physical package containing goods.

The amount of trade conducted electronically has grown rapidly with widespread Internet usage and has further increased with the proliferation of mobile computing devices capable of accessing the Internet. Such mobile computing devices include laptop computers, tablet computers, and handheld telephones. Expansion of the capabilities of such mobile devices has increased opportunities for electronic commerce to shorten the cycle of creation, production, and delivery of customized goods.

### SUMMARY

Various embodiments of methods and apparatus for coordinating production of an item by dynamically assigning production resources. In some embodiments, responsive to receiving from a customer an item request, a method includes deconstructing the item request from the customer into a plurality of order components, constructing a tentative assignment of the order components to a plurality of production resources. In some embodiments, the method includes communicating to the customer an estimate of a set of transaction satisfaction conditions derived from the tentative assignment. In some embodiments, the method includes, responsive to acceptance of the transaction satisfaction conditions, distributing the order components to the plurality of production resources.

### BRIEF DESCRIPTION OF THE DRAWINGS

FIG. 1 illustrates a distributed system that may implement production resource management for customized products, according to some embodiments.

FIG. 2 depicts a module that may implement production resource management for customized products, according to some embodiments.

FIG. 3 is a flowchart of a process for production resource management for customized products, according to some embodiments.

FIG. 4 is a flowchart of a process for production resource management for customized products, according to some embodiments.

FIG. 5 is a flowchart of a process for production resource management for customized products, according to some embodiments.

FIG. 6 is a flowchart of a process for production resource management for customized products, according to some embodiments.

FIGS. 7A-7P feature relationship diagram for production resource management for customized products, according to some embodiments.

FIG. 8 illustrates an example computer system that may be used in embodiments.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

### Brief Introduction to Production Resource Management for Customized Products

Some embodiments include a system for producing items using dynamically assigned production resources. In some embodiments, the system includes a processor and program instructions computer-executable to implement an order intake module configured to receive from a customer an item request, communicate to the customer an estimate of a set of transaction satisfaction conditions derived from a tentative assignment of order components to a plurality of production resources, and receive acceptance of the transaction satisfaction conditions.

In some embodiments, the system includes a production coordination module configured to, responsive to the customer item request, deconstruct the item request from the customer into a set (sometimes referred to herein as a plurality) of order components, and construct a tentative assignment of the plurality order components to the plurality of production resources. In some embodiments, the tentative assignment includes, for each of the plurality of order components, an identification of a task to be performed by a selected one of the plurality of production resources, an accounting of any dependencies that exist between ones of the plurality of order components, and expected scheduling of completion for each task.

In some embodiments, the production coordination module is configured to generate from the tentative assignment the transaction satisfaction conditions. In some embodiments, the production coordination module is configured to, responsive to acceptance of the transaction satisfaction conditions, distribute the order components to selected ones of the plurality of production resources. In some embodiments, the production resources include automated manufacturing systems, and the order components include automated instructions for causing the automated manufacturing systems to generate products or components of products through automated control.

In some embodiments, resources can report readiness and scheduling can be based on the readiness reports. In some embodiments, the system further includes a production resource reporting module configured to receive reports of statuses of the production resources. In some embodiments, the order coordination module is further configured to develop a suborder component availability schedule reflecting reported levels of task availability at each of the respective production resources.

In some embodiments, resources can report readiness and pricing can be based on the readiness reports. In some embodiments, the system further includes a production resource reporting module configured to receive reports of statuses of the production resources, and the order intake module is further configured to develop the estimate of the set of transaction satisfaction conditions reflecting reported levels of task availability at each of the respective production resources.

In some embodiments, resources can report input availability and pricing can be based on the input availability. In some embodiments, In some embodiments, the system further includes a production resource reporting module configured to receive reports of availabilities of inputs to the production resources, and the order intake module is further configured to develop the estimate of the set of transaction satisfaction conditions reflecting reported levels of availabilities of inputs at each of the respective production resources.

In some embodiments, resources can report input availability and assignment can be based on the input availability. In some embodiments, the system further includes a production resource reporting module configured to receive reports of statuses of the production resources, and the order coordination module is further configured to construct a tentative assignment of the order components to the plurality of production resources based at least in part upon reported levels of task availability at each of the respective production resources.

In some embodiments, resources can report input performance and pricing can be based on performance. In some embodiments, the system further comprises a production resource reporting module configured to receive reports of performance of previous order components by the plurality of production resources, and the order intake module is further configured to develop the estimate of the set of transaction satisfaction conditions reflecting performance of the previous order components by the plurality of production resources.

In some embodiments, resources can report performance and assignment can be based on performance. In some embodiments, the system further includes a production resource reporting module configured to receive reports of previous order components by the plurality of production resources, and the order coordination module is further configured to construct a tentative assignment of the order components to the plurality of production resources based at least in part upon performance of previous order components by the plurality of production resources.

Some embodiments include a method for coordinating production of an item by dynamically assigning production resources. In some embodiments, the method includes, responsive to receiving from a customer an item request, deconstructing the item request from the customer into a plurality of order components, constructing a tentative assignment of the order components to a plurality of production resources. In some embodiments, the method includes communicating to the customer an estimate of a set of transaction satisfaction conditions derived from the tentative assignment. In some embodiments, the method includes, responsive to acceptance of the transaction satisfaction conditions, distributing the order components to the plurality of production resources.

Some embodiments further include providing an estimate to the user and letting the user make changes that are iteratively plugged into the estimate. In some embodiments, the method further includes presenting to the customer an interface for, upon processing of the item request, iteratively reviewing the transaction satisfaction conditions of the item request, and allowing iterative modification of options associated with the item request. In some embodiments, the method further includes, responsive to the modification of the options associated with the item request, constructing a revised tentative assignment of revised order components to a revised plurality of production resources, and communicating to the customer a revised estimate of a set of revised transaction satisfaction conditions derived from the revised tentative assignment. In some embodiments, the method further includes, responsive to acceptance of the revised estimate of the set of the revised transaction satisfaction conditions, distributing the revised order components to the revised plurality of production resources.

Some embodiments further include providing a suborder breakdown with dependencies. In some embodiments, the method further includes, for each order component of the plurality of order components, iteratively identifying for a set of item options a set of production resources capable of producing the order component. In some embodiments, the iteratively identifying further includes iteratively identifying a set of suborder components of the each order component of the plurality of order components, and iteratively tentatively assigning production of the each suborder component to a suborder component production resource selected based at least in part on a set of production criteria related to production options selected for a respective order component associated with the suborder component, such that production of the set of suborder components satisfies criteria associated with the respective order component.

Some embodiments further include locking resources during estimating process. In some embodiments, the tentative assignments include locks for excluding use of resources for a specified period, and the constructing the revised tentative assignment of the order components to the revised plurality of production resources further includes releasing tentative assignments to production resources, and making revised tentative assignments to a revised set of production resources.

In some embodiments, the plurality of order components represents a plurality of components of the item to be produced by a respective ones of a plurality of production resources. In some embodiments, constructing a tentative assignment of the order components to a plurality of production resources further includes developing a suborder component availability schedule reflecting reported levels of task availability at each of the respective production resources.

In some embodiments, pricing drives suborder component assignment. In some embodiments, constructing a tentative assignment of the order components to a plurality of production resources further comprises developing a suborder component availability schedule reflecting resource pricing at each of the respective production resources.

Some embodiments include a non-transitory computer-readable storage medium storing program instructions. In some embodiments, the program instructions are computer-executable to implement, responsive to receiving from a customer an item request, deconstructing the item request from the customer into a plurality of order components, constructing a tentative assignment of the order components to a plurality of production resources, communicating to the customer an estimate of a set of transaction satisfaction conditions derived from the tentative assignment, responsive to acceptance of the transaction satisfaction conditions, distributing the order components to the plurality of production resources.

Some embodiments further include program instructions computer-executable to implement presenting to the customer an interface for upon processing of the item request, iteratively reviewing the transaction satisfaction conditions of the item request, and allowing iterative modification of options associated with the item request. Some embodiments further include program instructions computer-executable to implement, responsive to the modification of the options associated with the item request, constructing a revised tentative assignment of revised order components to a revised plurality of production resources, and communicating to the customer a revised estimate of a set of revised transaction satisfaction conditions derived from the revised tentative assignment. Some embodiments further include program instructions computer-executable to implement, responsive to acceptance of the revised estimate of the set of the revised transaction satisfaction conditions, distributing the revised order components to the revised plurality of production resources.

Some embodiments further include program instructions computer-executable to implement, for each order component of the plurality of order components, iteratively identifying for a set of item options a set of production resources capable of producing the order component. In some embodiments, the program instructions computer-executable to implement iteratively identifying further comprise program instructions computer-executable to implement iteratively identifying a set of suborder components of the each order component of the plurality of order components, and program instructions computer-executable to implement iteratively tentatively assigning production of the each suborder component to a suborder component production resource selected based at least in part on a set of production criteria related to production options selected for a respective order component associated with the suborder component, such that production of the set of suborder components satisfies criteria associated with the respective order component.

In some embodiments, the tentative assignments comprise locks for excluding use of resources for a specified period, and the program instructions computer-executable to implement constructing the revised tentative assignment of the order components to the revised plurality of production resources further program instructions computer-executable to implement releasing tentative assignments to production resources, and program instructions computer-executable to implement making revised tentative assignments to a revised set of production resources. In some embodiments, the plurality of order components represents a plurality of components of the item to be produced by a respective ones of a plurality of production resources.

In some embodiments, the program instructions computer-executable to implement constructing a tentative assignment of the order components to a plurality of production resources further include program instructions computer-executable to implement developing a suborder component availability schedule reflecting reported levels of task availability at each of the respective production resources.

### Introduction to Use of Technical Terminology

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Various embodiments of methods and apparatus for coordinating production of an item by dynamically assigning production resources are described herein. In some embodiments, a method includes, responsive to receiving from a customer an item request. In some embodiments, the method includes deconstructing the item request from the customer into a plurality of order components, constructing a tentative assignment of the order components to a plurality of production resources. In some embodiments, the method includes communicating to the customer an estimate of a set of transaction satisfaction conditions derived from the tentative assignment. In some embodiments, the method includes, responsive to acceptance of the transaction satisfaction conditions, distributing the order components to the plurality of production resources.

Some embodiments may include a means for coordinating production of an item by dynamically assigning production resources are described herein. For example, a production resource management module may, responsive to receiving from a customer an item request, deconstruct the item request from the customer into a plurality of order components, construct a tentative assignment of the order components to a plurality of production resources, communicate to the customer an estimate of a set of transaction satisfaction conditions derived from the tentative assignment, and, responsive to acceptance of the transaction satisfaction conditions, distribute the order components to the plurality of production resources, as described herein. The production resource management module may in some embodiments be implemented by a non-transitory, computer-readable storage medium and one or more processors (e.g., CPUs and/or GPUs) of a computing apparatus. The computer-readable storage medium may store program instructions executable by the one or more processors to cause the computing apparatus to responsive to receiving from a customer an item request, deconstruct the item request from the customer into a plurality of order components, construct a tentative assignment of the order components to a plurality of production resources, communicate to the customer an estimate of a set of transaction satisfaction conditions derived from the tentative assignment, and, responsive to acceptance of the transaction satisfaction conditions, distribute the order components to the plurality of production resources, as described herein. Other embodiments of the non-uniform paint loading module may be at least partially implemented by hardware circuitry and/or firmware stored, for example, in a non-volatile memory.

### Example Implementations

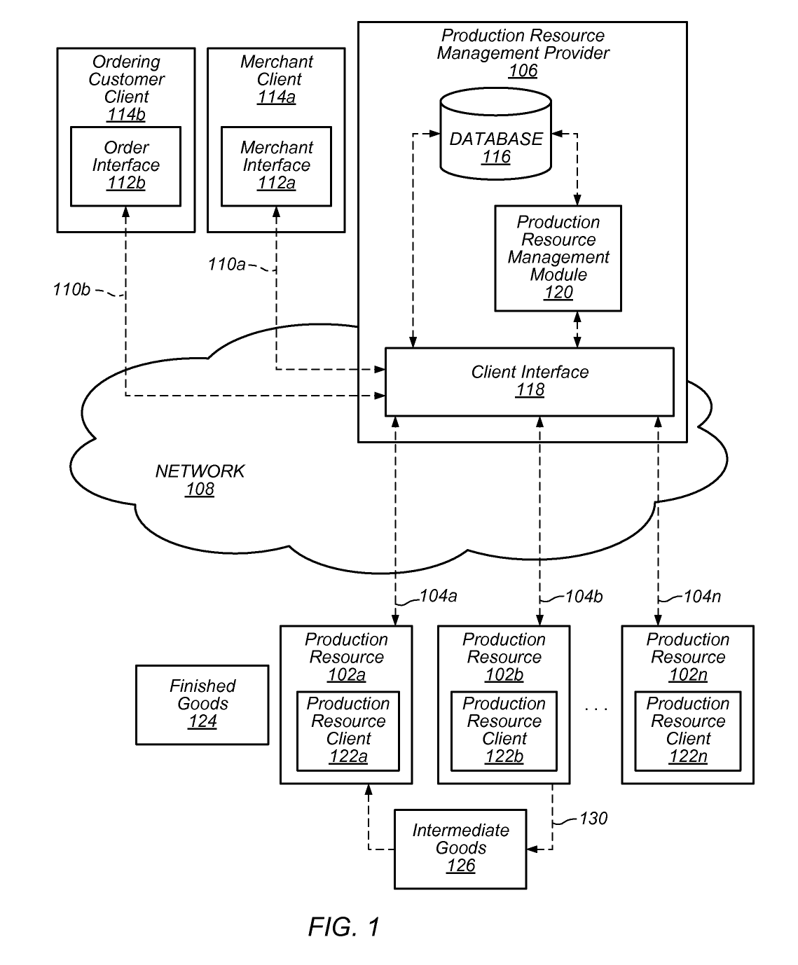

FIG. 1 illustrates a distributed system that may implement production resource management for customized products, according to some embodiments. In some embodiments, a production resource management provider 106 performs functions for arranging transactions, tracking, managing and reporting of production related to transactions, and otherwise supervising production that includes dynamically assigned production resources.

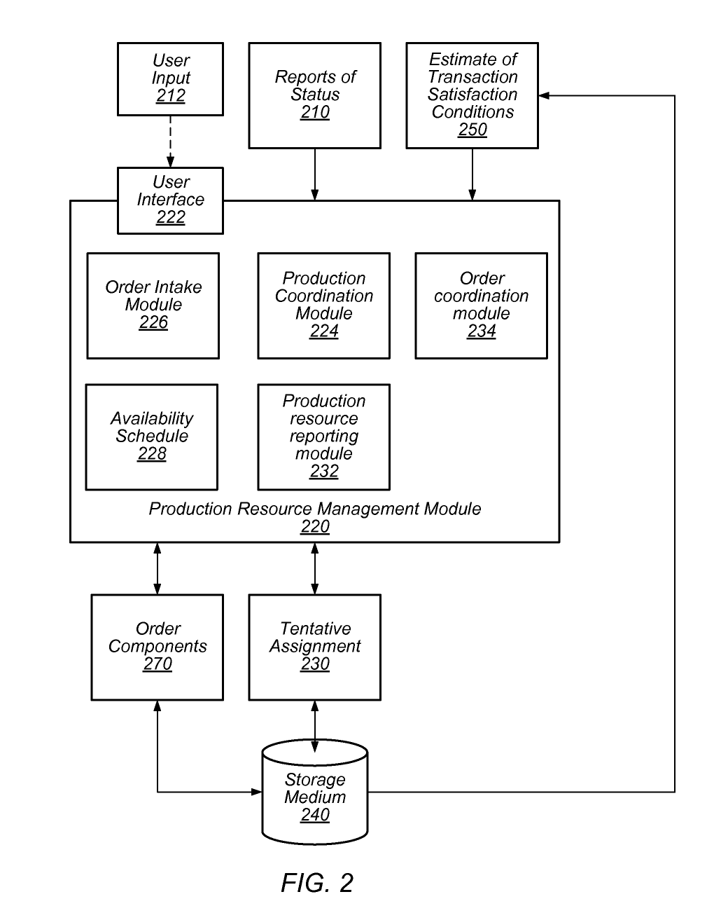

In some embodiments, a production resource management provider 106 is a system for producing items, such as finished goods 124, using dynamically assigned production resources 102a-102n. In some embodiments, production resource management provider 106 includes a processor and program instructions computer-executable to implement a database 116, a production resource management module 120 (described in further detail below with respect to FIG. 2) and a client interface 118 for communicating over a network 108 with a merchant client 114a presenting a merchant interface 112a, an ordering customer client 114b presenting an order interface 112b, and production resource clients 122a-122n associated with respective ones of production resources 102a-102n.

In some embodiments, merchant client 114a presents a merchant interface 112a for allowing a merchant user to negotiate terms for production of finished goods 124 or intermediate goods 126 by production resources 102a-102n in response to orders placed by a customer ordering client 114b using an ordering interface 112b.

In some embodiments, production resource management module 120 includes an order intake module (not shown) configured to receive from a customer over a communication link 110b using an order interface 112b an item request. In some embodiments, production resource management module 120 may also communicate to the customer over a communication link 110b using an order interface 112b an estimate of a set of transaction satisfaction conditions derived from a tentative assignment of order components to a plurality of production resources 102a-102n, and receive acceptance of the transaction satisfaction conditions over a communication link 110b using an order interface 112b.

In some embodiments, production resource management module 120 includes a production coordination module (not shown) configured to, responsive to the customer item request received from a customer over a communication link 110b using an order interface 112b, deconstruct the item request from the customer into a plurality of order components, and construct a tentative assignment of the plurality of order components to the plurality of production resources. In some embodiments, the tentative assignment further includes for each of the plurality of order components, an identification of a task to be performed by a selected one of the plurality of production resources 102a-102n, such as production of finished goods 124 or of intermediate goods 126 for routing over transport links 130, and an accounting of any dependencies that exist between ones of the plurality of order components, and an expected scheduling of completion for each task.

In some embodiments, production resource management module 120 includes a production coordination module (not shown) configured to generate from the tentative assignment the transaction satisfaction conditions and, responsive to acceptance of the transaction satisfaction conditions, distribute the order components over communication links 140a-104n to the plurality of production resources 102a-102n. In some embodiments, production resources 102a-102n are automated manufacturing systems, such as fabrication machines (e.g., three-dimensional printers, computer-controlled metal presses, computer-controlled kilns, computer-controlled blast furnaces or computer-controlled molding machines). In some embodiments, order components are automated instructions, such as product specifications and dimensions, that cause the fabrication machines (e.g., three-dimensional printers, computer-controlled metal presses, computer-controlled kilns, computer-controlled blast furnaces or computer-controlled molding machines) to generate products or components of products through automated control (e.g., without direct human intervention).

In some embodiments, production resource management module 120 includes a production resource reporting module (not shown) configured to receive reports of statuses of the production resources 102a-102n over network 108 and an order coordination module (not shown) of production resource management module 120 is further configured to develop a suborder component availability schedule reflecting reported levels of task availability at each of the respective production resources 102a-102n.

In some embodiments, production resource management module 120 includes a production resource reporting module (not shown) configured to receive reports of statuses of the production resources 102a-102n over network 108 and an order intake module (not shown) of production resource management module 120 is further configured to develop the estimate of the set of transaction satisfaction conditions reflecting reported levels of task availability at each of the respective production resources.

In some embodiments, production resource management module 120 includes a production resource reporting module (not shown) configured to receive reports of availabilities of inputs to the production resources 102a-102n over network 108 and an order intake module (not shown) of production resource management module 120 is further configured to develop the estimate of the set of transaction satisfaction conditions reflecting reported levels of availabilities of inputs at each of the respective production resources.

In some embodiments, production resource management module 120 includes a production resource reporting module (not shown) configured to receive reports of statuses of the production resources 102a-102n over network 108 and an order intake module (not shown) of production resource management module 120 is further configured to construct a tentative assignment of the order components to the plurality of production resources 102a-102n based at least in part upon reported levels of task availability at each of the respective production resources 102a-102n.

In some embodiments, production resource management module 120 includes a production resource reporting module (not shown) configured to receive reports of statuses of the production resources 102a-102n over network 108 and an order intake module (not shown) of production resource management module 120 is further configured to develop the estimate of the set of transaction satisfaction conditions reflecting performance of the previous order components by the plurality of production resources 102a-102n.

In some embodiments, production resource management module 120 includes a production resource reporting module (not shown) configured to receive reports of statuses of the production resources 102a-102n over network 108 and an order intake module (not shown) of production resource management module 120 is further configured to construct a tentative assignment of the order components to the plurality of production resources based at least in part upon performance of previous order components by the plurality of production resources.

FIG. 2 depicts a module that may implement production resource management for customized products, according to some embodiments. A production resource management module 220 includes a production coordination module 224 and an order intake module 226 that interact with an availability schedule 228 for production resources (not shown) to develop order components 270, tentative assignments of order components 230, and estimates of transaction satisfaction conditions 250, which may be committed to a storage medium. Reports of status 210 may be received from production resources and used as described herein, and user input 212 is received over a user interface 222, as described herein.

Order intake module 226 is configured to receive from a customer (e.g., over a communication link) using an order interface user interface 212 an item request in user input 212. In some embodiments, production resource management module 220 may also communicate to the customer using user interface 222 an estimate of a set of transaction satisfaction conditions 250 derived from a tentative assignment 230 of order components 270 to a plurality of production resources and receive acceptance of the transaction satisfaction conditions using user interface 222.

In some embodiments, production resource management module 220 includes a production coordination module 224 configured to, responsive to the customer item request received as user input 212 from a customer over a user interface 222, deconstruct the item request from the customer into a plurality of order components 270, and construct a tentative assignment 230 of the plurality of order components to the plurality of production resources (not shown). In some embodiments, the tentative assignment 230 further includes for each of the plurality of order components 270, an identification of a task to be performed by a selected one of the plurality of production resources, such as production of finished goods or of intermediate goods for routing over transport links, and an accounting of any dependencies that exist between ones of the plurality of order components, and an expected scheduling of completion for each task.

In some embodiments, production resource management module 220 includes a production coordination module (not shown) 224 configured to generate from the tentative assignment 230 an estimate of the transaction satisfaction conditions 250 and, responsive to receipt as user input 212 through user interface 222 of acceptance of the transaction satisfaction conditions 250, distribute the order components 270 to the plurality of production resources.

In some embodiments, production resource management module 220 includes a production resource reporting module 232 configured to receive reports of status 210 of the production resources and an order coordination module 234 of production resource management module 220 is further configured to develop a suborder component availability schedule (as part of availability schedule 228) reflecting reported levels of task availability at each of the respective production resources.

In some embodiments, production resource management module 220 includes a production resource reporting module 234 configured to receive reports of statuses 210 of the production resources an order intake module 226 of production resource management module 220 is further configured to develop the estimate of the set of transaction satisfaction conditions 250 reflecting reported levels of task availability at each of the respective production resources.

In some embodiments, production resource management module 220 includes a production resource reporting module 232 configured to receive reports of availabilities of inputs to the production resources as parts of reports of status 210 an order intake module 226 of production resource management module 220 is further configured to develop the estimate of the set of transaction satisfaction conditions reflecting reported levels of availabilities of inputs at each of the respective production resources.

In some embodiments, production resource management module 220 includes a production resource reporting module 232 configured to receive reports of statuses 210 of the production resources and an order intake module 226 of production resource management module 220 is further configured to construct a tentative assignment 230 of the order components 270 to the plurality of production resources based at least in part upon reported levels of task availability at each of the respective production resources.

In some embodiments, production resource management module 120 includes a production resource reporting module 232 configured to receive reports of statuses 210 of the production resources and an order intake module 226 of production resource management module 220 is further configured to develop the estimate of the set of transaction satisfaction conditions 250 reflecting performance of the previous order components 270 by the plurality of production resources.

In some embodiments, production resource management module 220 includes a production resource reporting module 232 configured to receive reports of statuses 210 of the production resources and an order intake module 226 of production resource management module 220 is further configured to construct a tentative assignment 230 of the order components 270 to the plurality of production resources based at least in part upon performance of previous order components 270 by the plurality of production resources.

In some embodiments, production coordination module 224 performs constructing a tentative assignment of the order components to a plurality of production resources, which includes determining product availability. In some embodiments, production coordination module 224 performs constructing a tentative assignment of the order components to a plurality of production resources, which includes ecommerce order to work order mapping and can be based at least in part on factors including both product features and system integrity. In some embodiments, ecommerce order to work order mapping based at least in part on product features includes mapping between work order elements and shopping cart elements, such that in some embodiments one feature maps to many work order elements. Mapping between work order elements and shopping cart elements, such that in some embodiments one feature maps to many work order elements may include fixed element mapping and dynamic element mapping. Fixed element mapping may include mapping materials, options and price. Dynamic element mapping may include mapping materials, options and price.

In some embodiments, ecommerce order to work order mapping based at least in part on product features includes recursive sub-assembly work orders from ecommerce orders. In some embodiments, ecommerce order to work order mapping based at least in part on product features includes services as well as goods, such as commissioned works.

Services or services bundled with goods may include music, movies, written materials and art work, such as custom painting of a finished physical good. Sub-assembly work orders from ecommerce orders may include fixed element mapping or dynamic element mapping. Fixed element mapping may include mapping materials, options and price. Dynamic element mapping may include mapping materials, options and price.

In some embodiments, constructing a tentative assignment of the order components to a plurality of production resources includes constructing a tentative assignment of the order components to a plurality of production resources based in part on pricing. In addition to fixed pricing, algorithmic pricing calculations are available, as are pricing based upon perishable factors and an algorithmic engine for price minimization that calculates the lowest possible price through adjustment of variables. For algorithmic pricing calculations, pricing can be determined based on elements selected, materials selected, and shipping. For algorithmic pricing calculations, pricing can be determined based on elements selected to include standardized elements and customizations. For algorithmic pricing calculations, pricing can be determined based on shipping including drop shipping, shipping through a production resource management provider, and shipping at varying priority levels.

In some embodiments, constructing a tentative assignment of the order components to a plurality of production resources includes constructing a tentative assignment of the order components to a plurality of production resources based in part on pricing based upon perishable factors. In some embodiments, a price can be auctioned down based upon underutilized production resource equipment, underutilized materials, underutilized time, or underutilized production resources, as well as ratings for quality, production resources or timing. In some embodiments, a price can be algorithmically reduced based upon underutilized production resource equipment, underutilized materials, underutilized time, or underutilized production resources, as well as ratings for quality, production resources or timing.

In some embodiments, a price can be auctioned up based upon scarce production resource equipment, scarce materials, scarce time, as well as ratings for quality, production resources or timing. In some embodiments, a price can be algorithmically increased based upon scarce production resource equipment, scarce materials, scare time, as well as ratings for quality, production resource or timing.

In some embodiments, an algorithmic engine for price minimization calculates the lowest possible price through adjustment of variables. In some embodiments, all variables can be adjustable. In some embodiments, selected variables can be adjustable while others are fixed. In some embodiments, these variables include location of end-customer for shipping options.

In some embodiments, production resource management module 220 handles payments, including one-time payments, recurring payments, tips and bonuses, and payments with accounting and reporting. In some embodiments, one-time payments include full payment upon receipt, full payment up front, and partial payment up front. Full payment up front includes payment paid to production resources immediately, and an escrow service that can provide payment upon satisfactory receipt of goods or services or a payment withheld until a dispute is resolved. Partial payment up front includes payment paid to production resources immediately, and an escrow service that can provide payment upon satisfactory receipt of goods or services or a payment withheld until a dispute is resolved.

Recurring payments include payments for the right to use creative goods or services. Types of services can include music, art work, written works, film works and other types of works. Recurring payments include payments for the right to use creative goods or services, which can include royalties and intellectual property rights payments for copyrights, design patents, utility patents and trademarks. Recurring payments include payments for the right to use creative goods or services, which can be split among contributors such as production resources and sub-production resources.

Tips and bonuses can include an online tip jar as well as bonuses from service providers for excellent ratings and feedback. In some embodiments, production resource management module handles system integrity through blind orders as well as ratings and feedback. Blind orders include blind orders to test timing, blind orders to test quality, blind orders to test shipping times, and confirmation of standards for certifications. Ratings and feedback can include ratings of production resources as well as ratings of customers for payment history, numbers of escrow complaints and numbers of returns.

In some embodiments, constructing a tentative assignment of the order components to a plurality of production resources includes determining product availability, which includes fixed timing, dynamic throttling of order completion, use of an algorithmic engine for timing minimization, tools for providing reporting transparency to the consumer, an algorithmic engine for optimized utilization, and an algorithmic engine for smoothing revenues.

Dynamic throttling of order completion includes routing to and managing particular production resources (e.g., production resources), handling outages (scheduled or unscheduled), dealing with availability of completed sub-assemblies (scheduled or unscheduled), addressing shipping constraints (scheduled, unscheduled, or based on shipping location), algorithmic outsourcing of sub-assemblies, handling of production resource equipment, and production resource equipment maintenance.

Dynamic throttling of order completion includes routing to and managing particular production resources (e.g., production resources), which includes certifying production resources, addressing time constraints of production resources, and handling algorithmic calculations of manufacturing factors. Addressing time constraints of production resources includes dealing with loading of other work orders and whether they are on time, delayed, how ratings for particular production resources are calculated, and feedback on quality. Addressing time constraints of production resources includes dealing with maker availability, whether scheduled or unscheduled.

Certifying production resources includes certification validation and handling of certification factors. Certification factors can include work quality, safety, specific production resource equipment usage, specific product assemblies, ratings, and feedback. Certification validation includes the handling of portable certifications that enable a maker to use production resource equipment in multiple facilities, certification for insurance coverage, and a database of certified production resources.

Algorithmic calculations of manufacturing factors includes managing and reporting percentages of manufacturing geography (e.g., made in USA or made in Texas), managing and reporting percentages of manufacturing by minorities (e.g., women, racial minorities, disabled people, veterans, and felons). Algorithmic calculations of manufacturing factors includes managing and reporting percentages of manufacturing materials, such as sustainable materials or recycled materials.

Dynamic throttling of order completion includes addressing shipping constraints (scheduled, unscheduled, or based on shipping location), such as drop-shipping to a customer and shipping to a production resource management provider for fulfillment.

Algorithmic outsourcing of sub-assemblies includes minimizing delays based on timing constraints, material constraints or production resource equipment constraints. Managing production resource equipment includes managing production resource equipment scheduling constraints based on production resource equipment utilization and production resource equipment unavailability, whether scheduled or unscheduled. Managing production resource equipment includes managing production resource equipment includes certifying locations with production resource equipment, certification for insurance coverage and a database of certified locations.

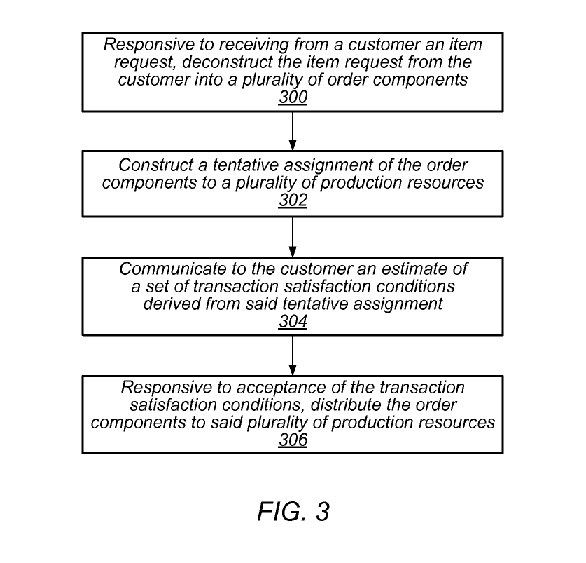

FIG. 3 is a flowchart of a process for production resource management for customized products, according to some embodiments. Responsive to receiving from a customer an item request, the item request from the customer is deconstructed into a plurality of order components (block 300). A tentative assignment of the order components to a plurality of production resources is constructed (block 302). An estimate of a set of transaction satisfaction conditions derived from the tentative assignment is communicated to the customer (block 304). Responsive to acceptance of the transaction satisfaction conditions, the order components are distributed to the plurality of production resources (block 306).

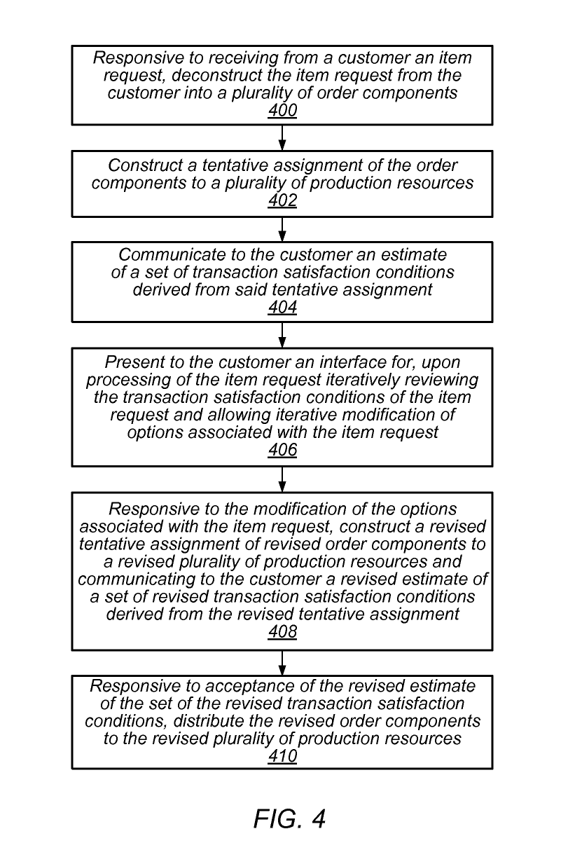

FIG. 4 is a flowchart of a process for production resource management for customized products, according to some embodiments. Responsive to receiving from a customer an item request, the item request from the customer is deconstructed into a plurality of order components (block 400). A tentative assignment of the order components to a plurality of production resources is constructed (block 402). An estimate of a set of transaction satisfaction conditions derived from the tentative assignment is communicated to the customer (block 404).

An interface for, upon processing of the item request iteratively reviewing the transaction satisfaction conditions of the item request and allowing iterative modification of options associated with the item request, is presented to the customer (block 406). Responsive to the modification of the options associated with the item request, a revised tentative assignment of revised order components to a revised plurality of production resources is constructed and a revised estimate of a set of revised transaction satisfaction conditions derived from the revised tentative assignment is communicated to the customer (block 408). Responsive to acceptance of the revised estimate of the set of the revised transaction satisfaction conditions, the revised order components are distributed to the revised plurality of production resources (block 410).

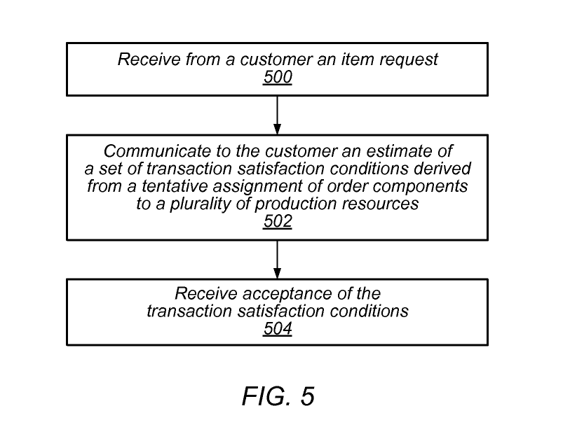

FIG. 5 is a flowchart of a process for production resource management for customized products, according to some embodiments. An item request is received from a customer (block 500). An estimate of a set of transaction satisfaction conditions derived from a tentative assignment of order components to a plurality of production resources is communicated to the customer (block 502). Acceptance of the transaction satisfaction conditions is received (block 504).

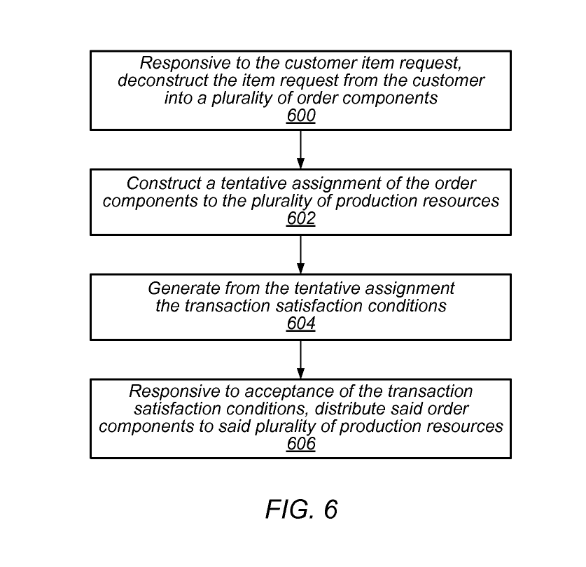

FIG. 6 is a flowchart of a process for production resource management for customized products, according to some embodiments. Responsive to the customer item request, the item request from the customer is deconstructed into a plurality of order components (block 600). A tentative assignment of the order components to the plurality of production resources is constructed (block 602). The tentative assignment is generated from the transaction satisfaction conditions (block 604). Responsive to acceptance of the transaction satisfaction conditions, the order components are distributed to the plurality of production resources (block 606).

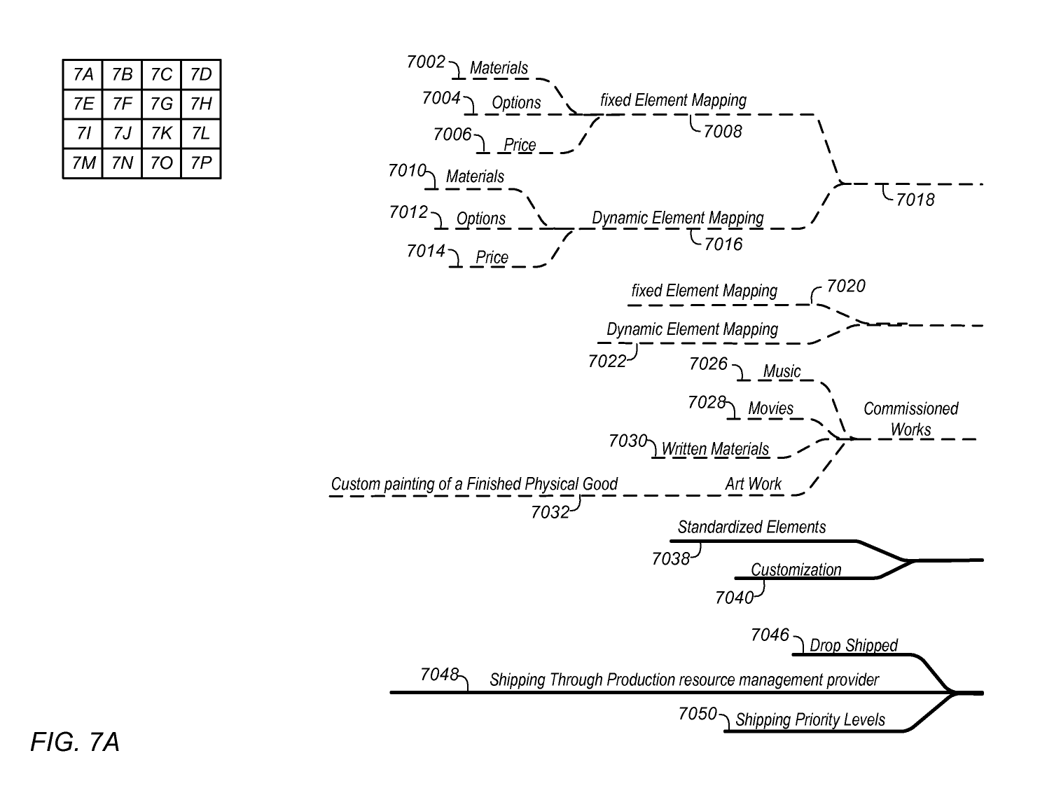

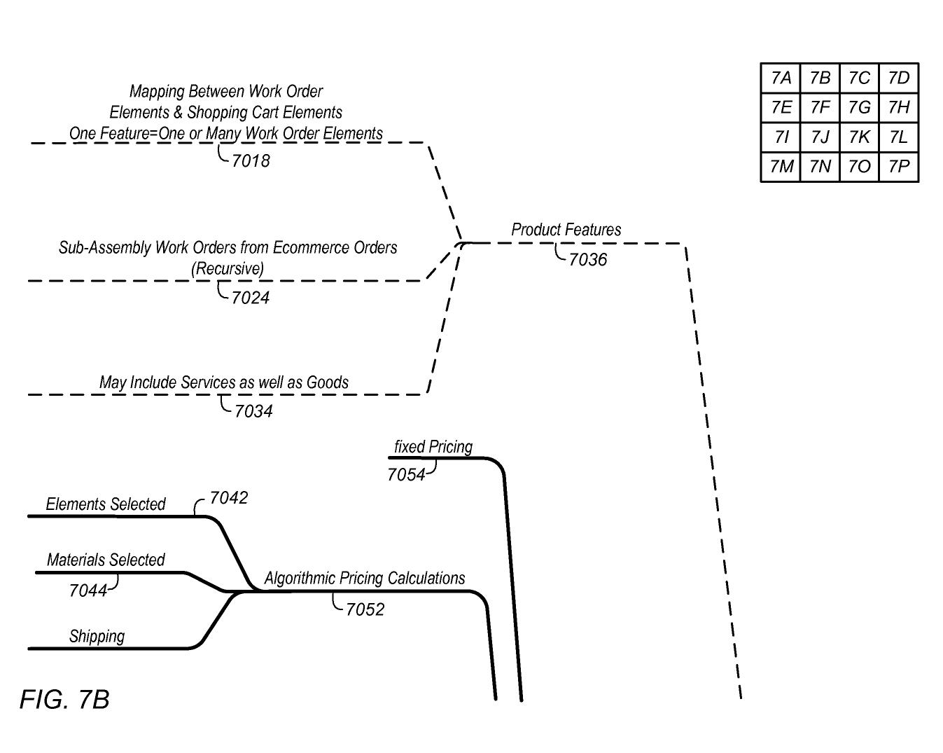

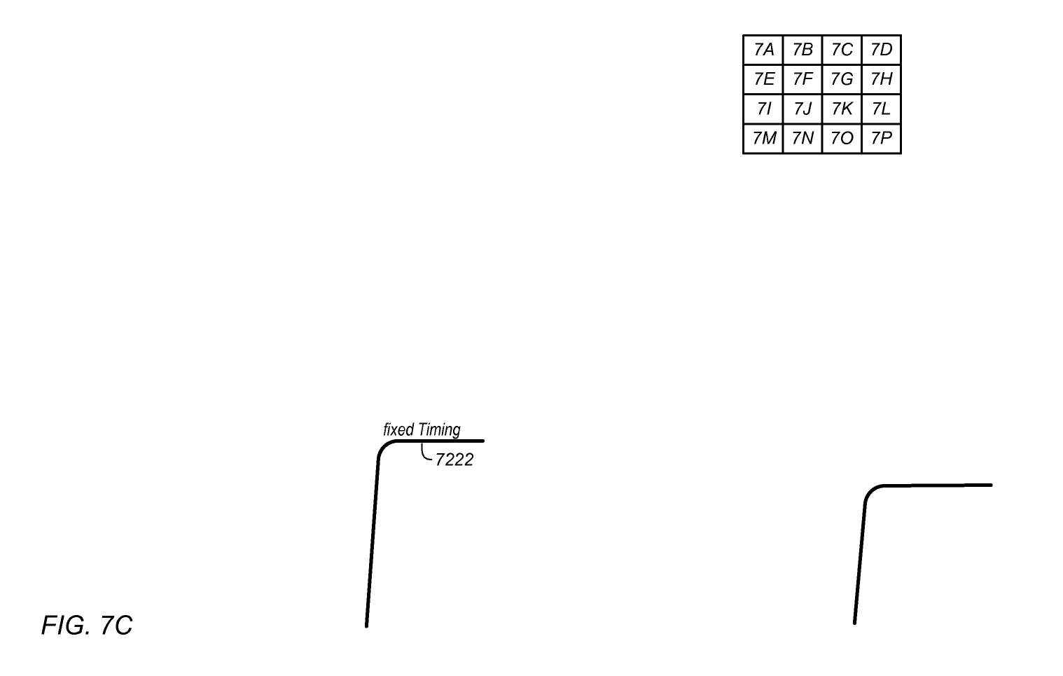

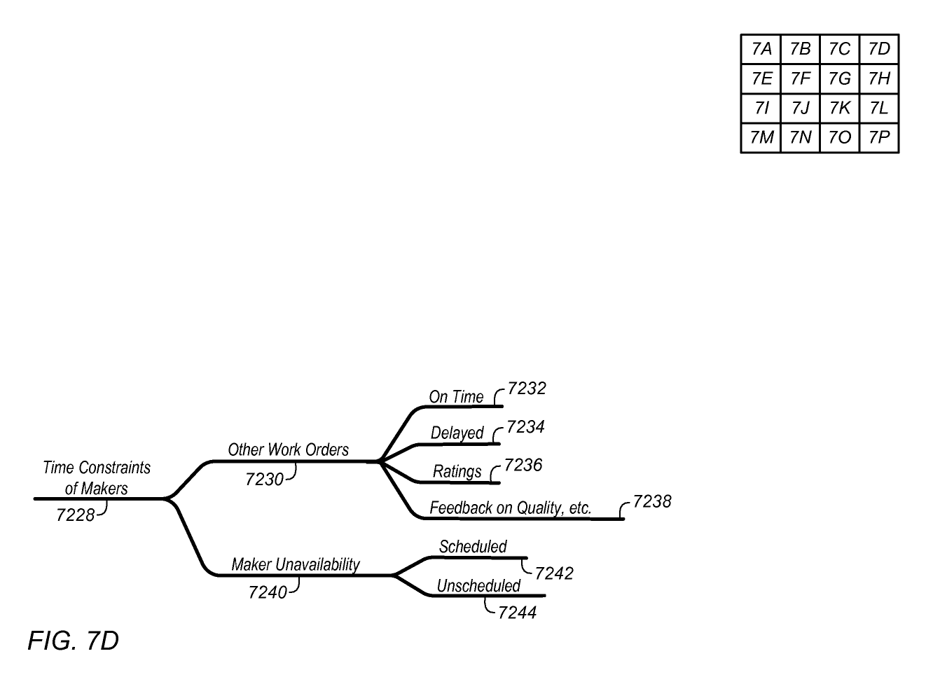

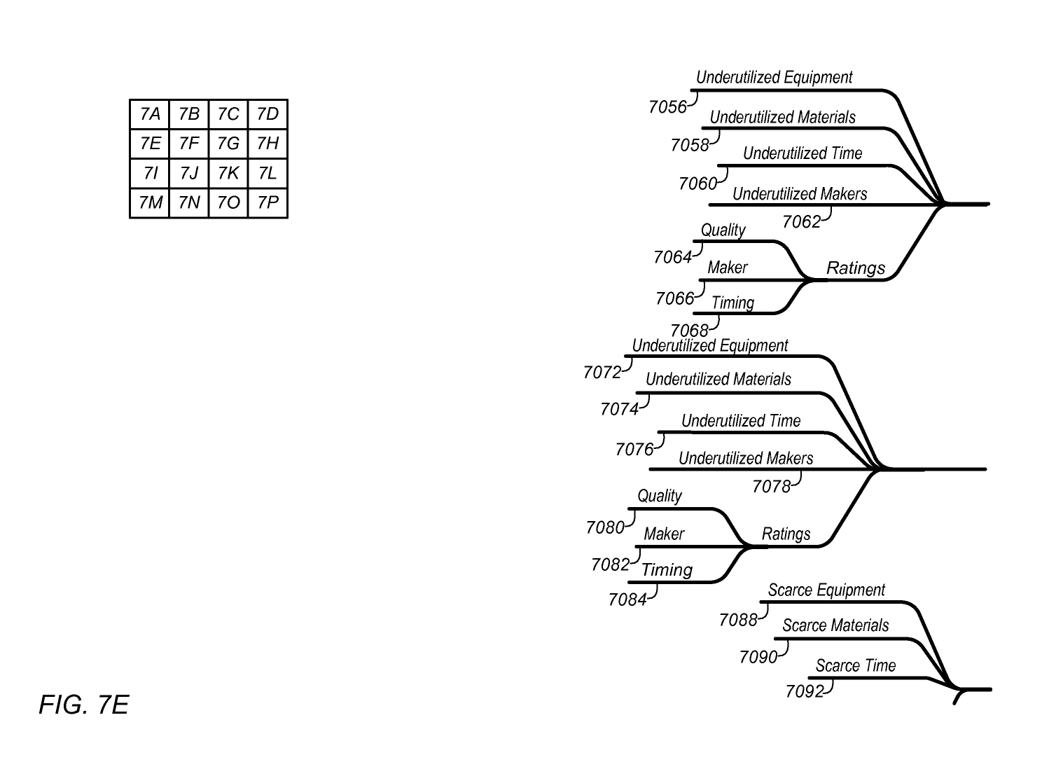

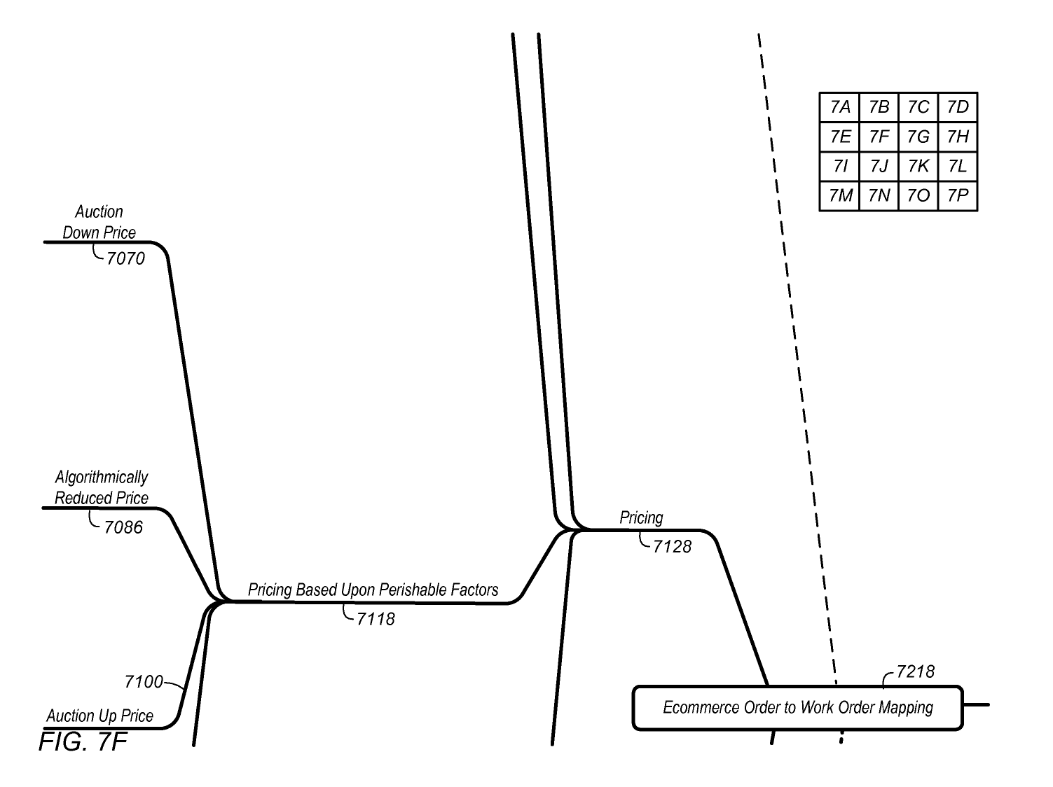

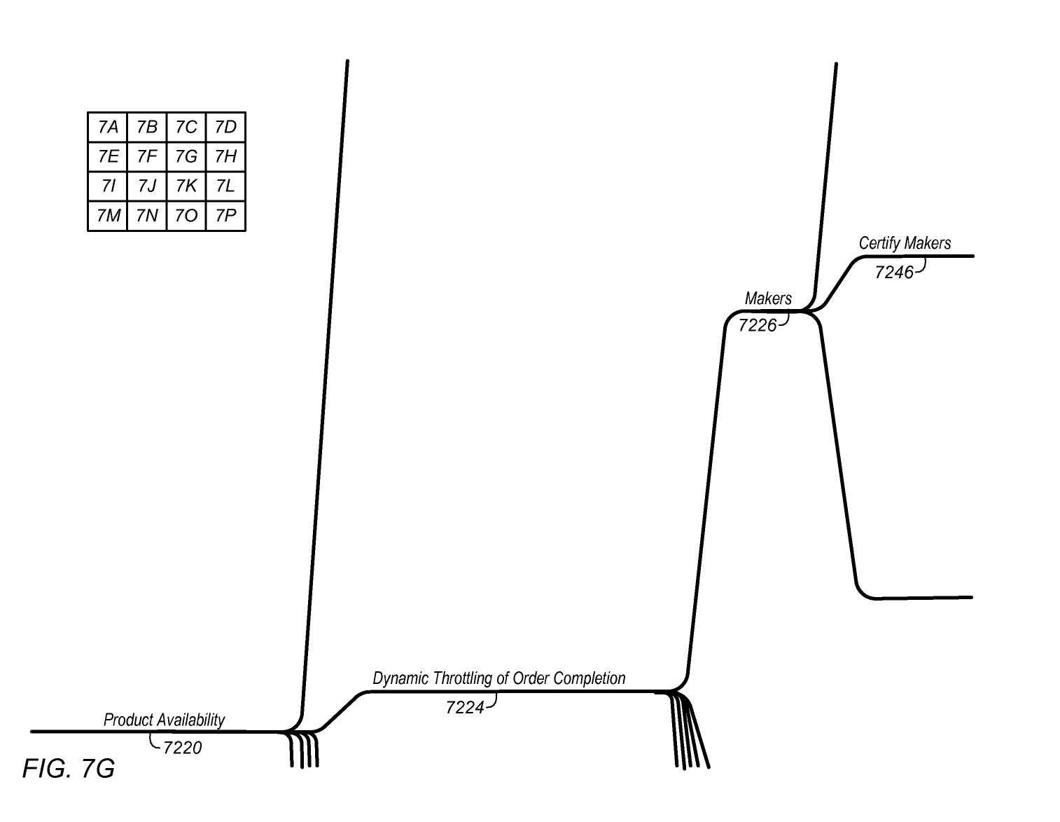

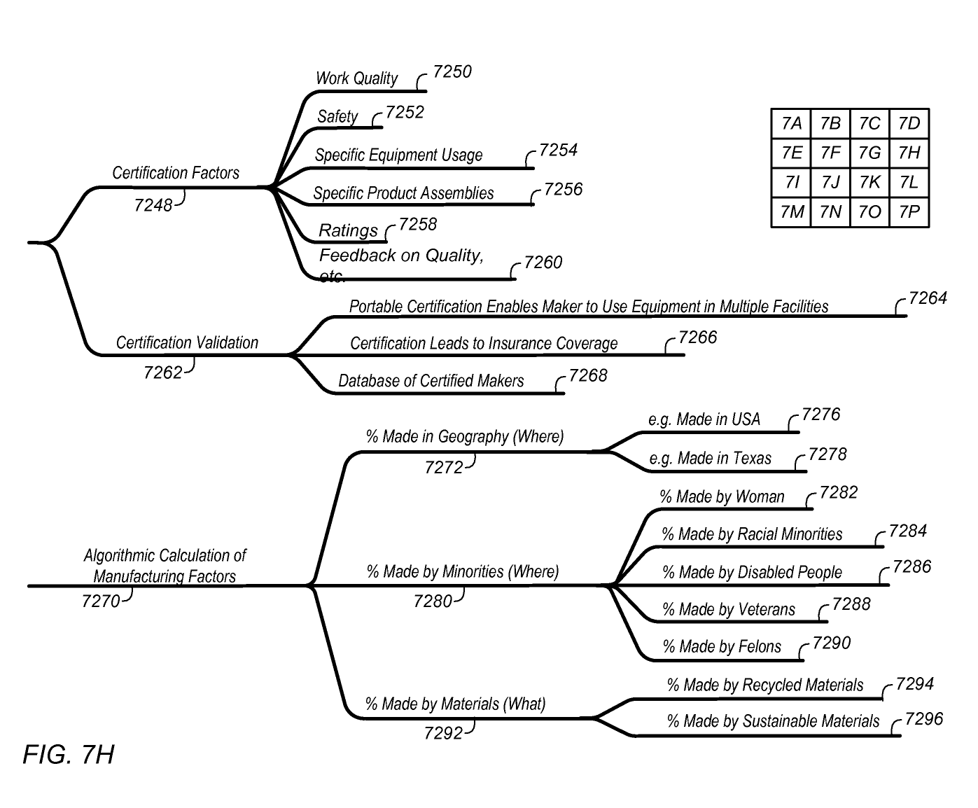

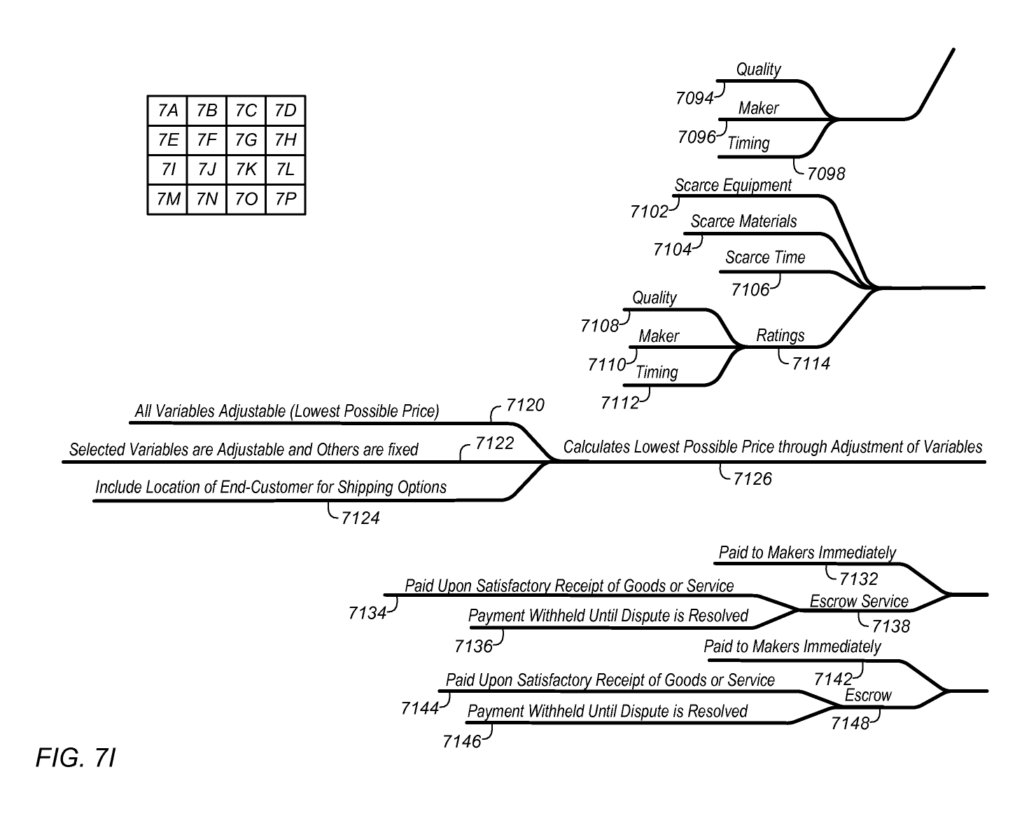

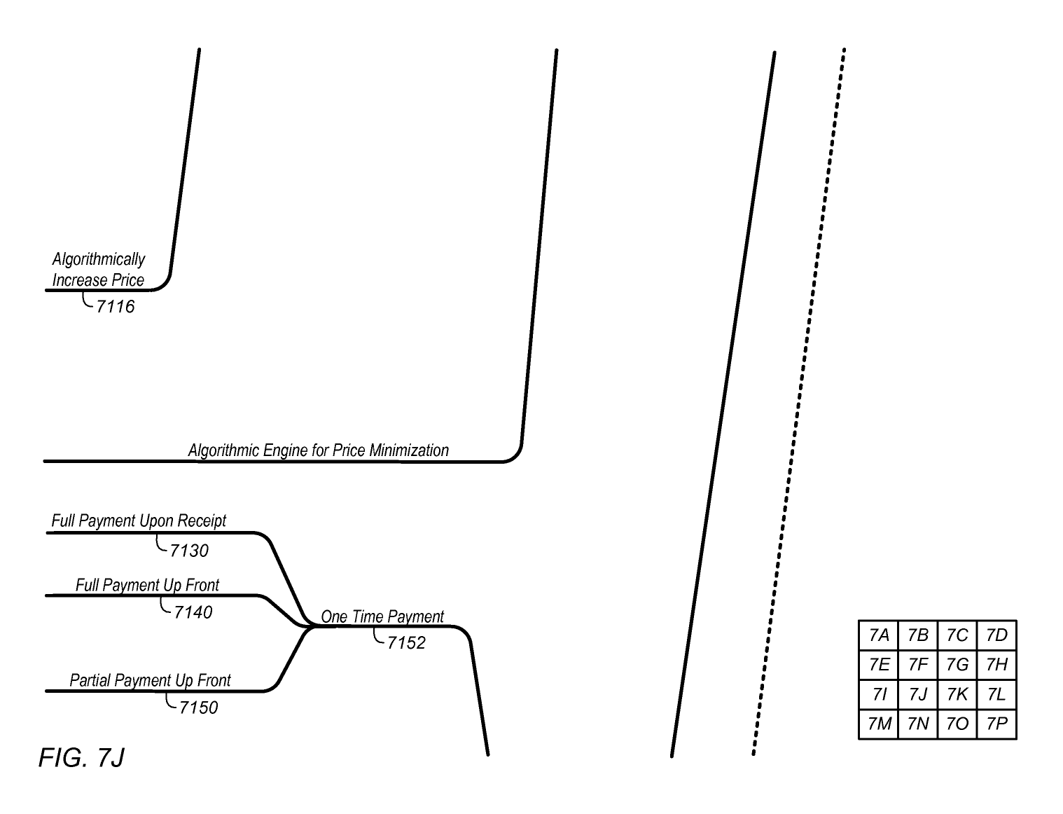

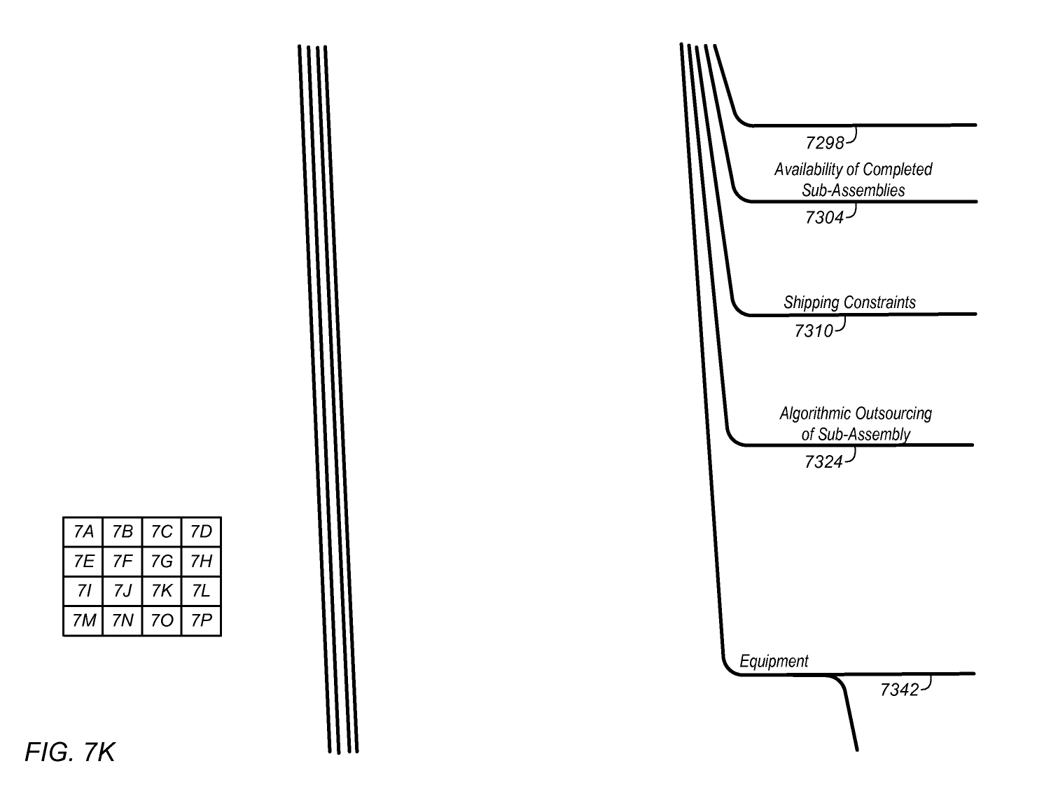

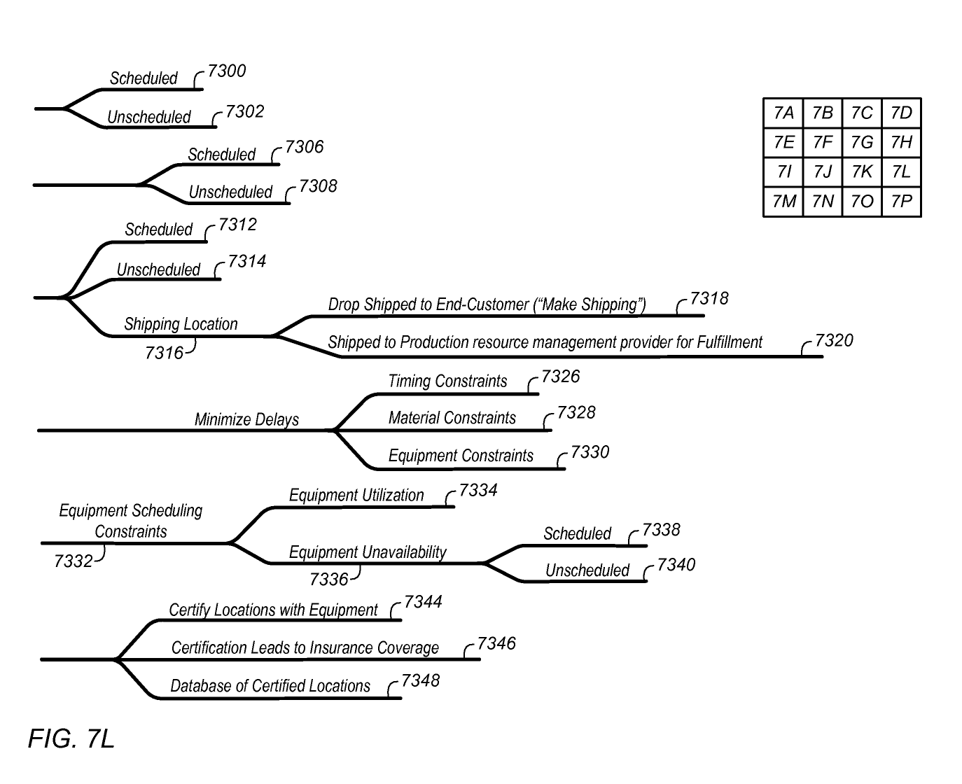

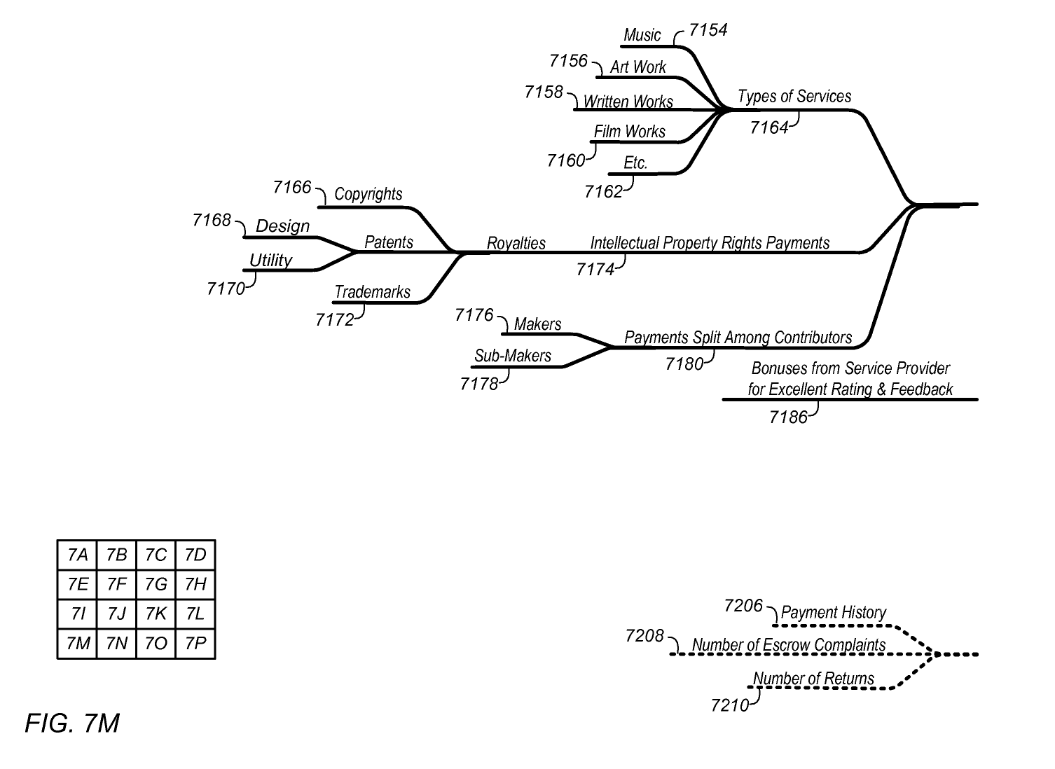

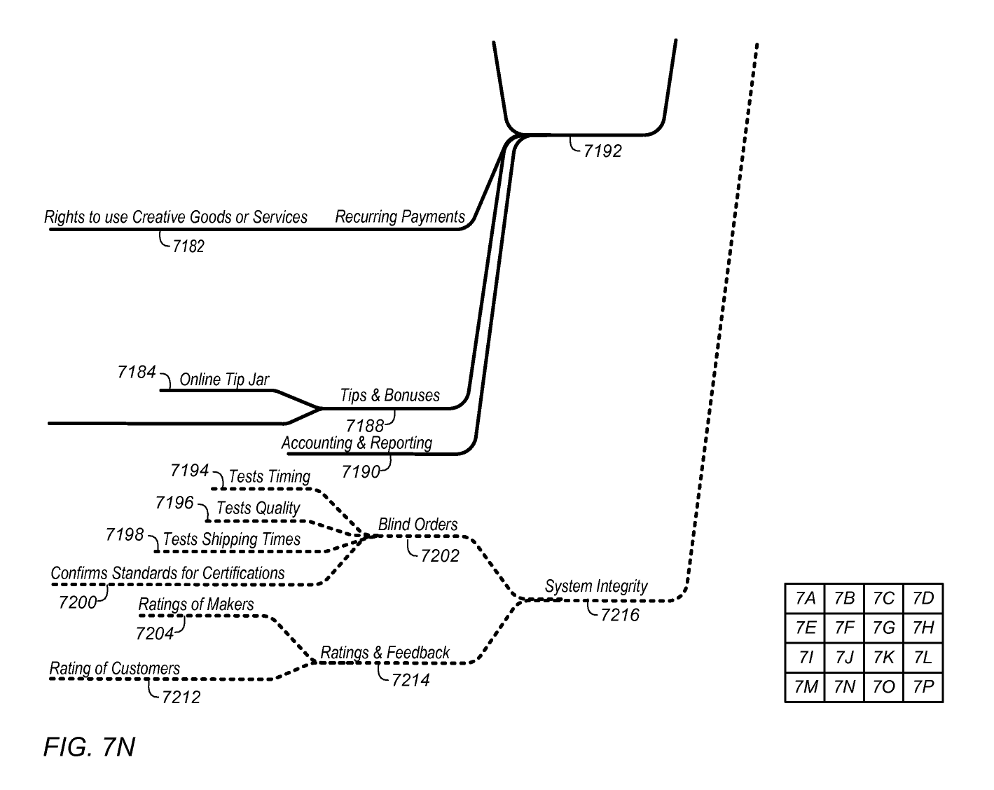

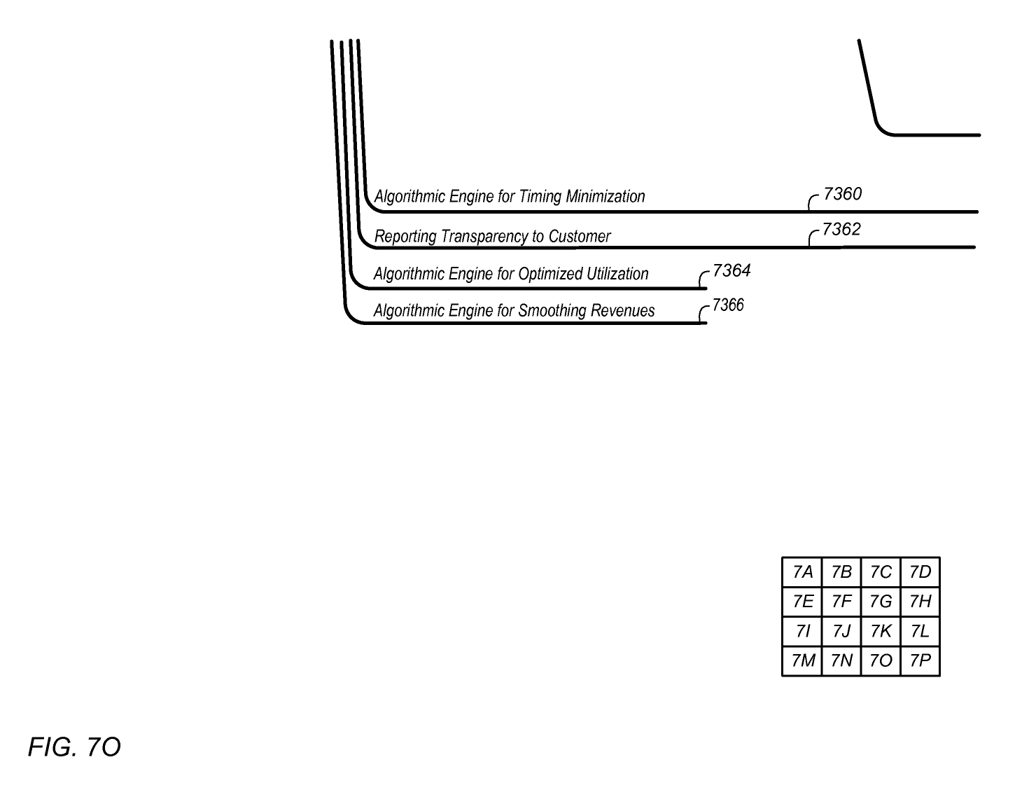

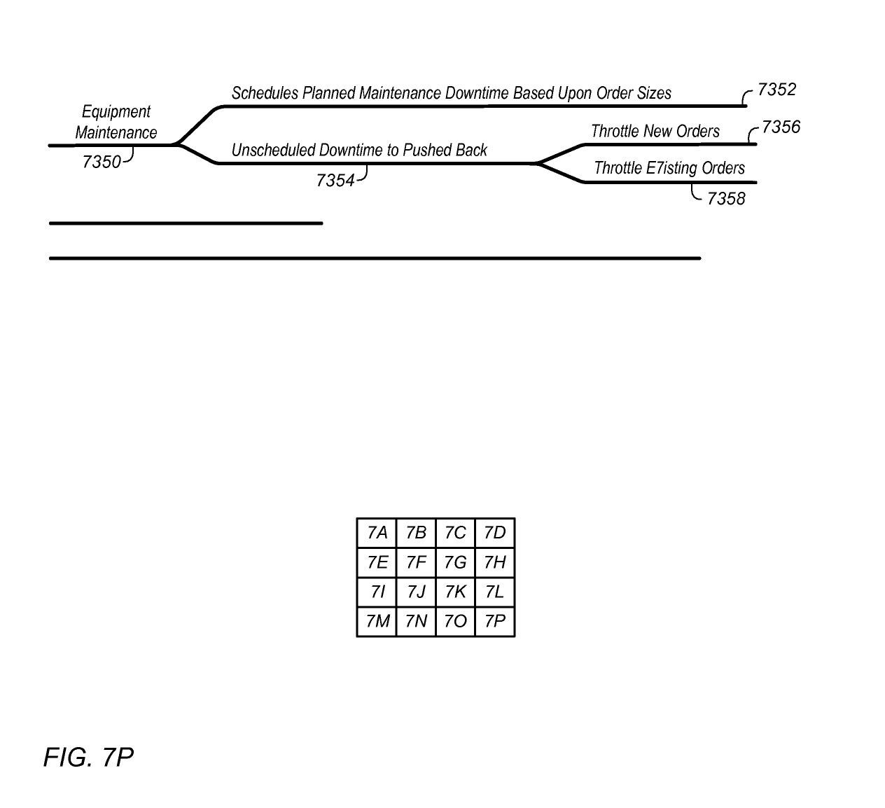

FIG. 7 is a feature relationship diagram for production resource management for customized products, according to some embodiments. In some embodiments, constructing a tentative assignment of the order components to a plurality of production resources includes determining product availability 7220. In some embodiments, constructing a tentative assignment of the order components to a plurality of production resources includes ecommerce order to work order mapping 7218, which can be based at least in part on factors including both product features 7036 and system integrity 7216. In some embodiments, ecommerce order to work order mapping 7218 based at least in part on product features 7036 includes mapping between work order elements and shopping cart elements 7018, such that in some embodiments one feature maps to many work order elements. Mapping between work order elements and shopping cart elements 7018, such that in some embodiments one feature maps to many work order elements may include fixed element mapping 7008 and dynamic element mapping 7016. Fixed element mapping 7008 may include mapping materials 7002, options 7004 and price 7006. Dynamic element mapping 7016 may include mapping materials 7010, options 7012 and price 7014.

In some embodiments, ecommerce order to work order mapping 7218 based at least in part on product features 7036 includes recursive sub-assembly work orders from ecommerce orders 7024. In some embodiments, ecommerce order to work order mapping 7218 based at least in part on product features 7036 includes services as well as goods 7034, such as commissioned works.

Services or services bundled with goods 7034 may include music 7026, movies 7028, written materials 7030 and art work, such as custom painting of a finished physical good 7032. Sub-assembly work orders from ecommerce orders may include fixed element mapping 7020 or dynamic element mapping 7022. Fixed element mapping 7020 may include mapping materials, options and price. Dynamic element mapping 7022 may include mapping materials, options and price.

In some embodiments, constructing a tentative assignment of the order components to a plurality of production resources includes constructing a tentative assignment of the order components to a plurality of production resources based in part on pricing 7128. In addition to fixed pricing 7054, algorithmic pricing calculations 7052 are available, as are pricing based upon perishable factors 7118 and an algorithmic engine for price minimization that calculates the lowest possible price through adjustment of variables 7126. For algorithmic pricing calculations 7052, pricing can be determined based on elements selected 7042, materials selected 7044, and shipping. For algorithmic pricing calculations 7052, pricing can be determined based on elements selected 7042 to include standardized elements 7038 and customizations 7040. For algorithmic pricing calculations 7052, pricing can be determined based on shipping including drop shipping 7046, shipping through a production resource management provider 7048, and shipping at varying priority levels 7050.

In some embodiments, constructing a tentative assignment of the order components to a plurality of production resources includes constructing a tentative assignment of the order components to a plurality of production resources based in part on pricing based upon perishable factors 7118. In some embodiments, a price can be auctioned down 7070 based upon underutilized equipment 7056, underutilized materials 7058, underutilized time 7060, or underutilized makers 7062, as well as ratings for quality 7064, makers 7066 or timing 7068. In some embodiments, a price can be algorithmically reduced 7086 based upon underutilized equipment 7072, underutilized materials 7074, underutilized time 7076, or underutilized makers 7078, as well as ratings for quality 7080, makers 7082 or timing 7084.

In some embodiments, a price can be auctioned up 7100 based upon scarce equipment 7088, scarce materials 7090, scarce time 7092, as well as ratings for quality 7094, makers 7096 or timing 7098. In some embodiments, a price can be algorithmically increased 7116 based upon scarce equipment 7102, scarce materials 7104, scare time 7106, as well as ratings 7114 for quality 7108, makers 7110 or timing 7112.

In some embodiments, an algorithmic engine for price minimization calculates the lowest possible price through adjustment of variables 7126. In some embodiments, all variables can be adjustable 7120. In some embodiments, selected variables can be adjustable while others are fixed 7122. In some embodiments, these variables include location of end-customer for shipping options 7124.

In some embodiments, production resource management module handles payments 7192, including one-time payments 7152, recurring payments, tips and bonuses 7188, and payments with accounting and reporting 7190. In some embodiments, one-time payments 7152 include full payment upon receipt 7130, full payment up front 7140, and partial payment up front 7150. Full payment up front 7140 includes payment paid to makers immediately 7132, and an escrow service 7138 that can provide payment upon satisfactory receipt of goods or services 7134 or a payment withheld until a dispute is resolved 7136. Partial payment up front 7150 includes payment paid to makers immediately 7142, and an escrow service 7148 that can provide payment upon satisfactory receipt of goods or services 7144 or a payment withheld until a dispute is resolved 7146.

Recurring payments include payments for the right to use creative goods or services 7182. Types of services 7164 can include music 7154, art work 7156, written works 7158, film works 7160 and other types of works 7162. Recurring payments include payments for the right to use creative goods or services 7182, which can include royalties and intellectual property rights payments 7174 for copyrights 7166, design patents 7168, utility patents 7170 and trademarks 7172. Recurring payments include payments for the right to use creative goods or services 7182, which can be split among contributors such as makers 7176 and sub-makers 7178. As used herein, a maker is a production resource.

Tips and bonuses 7188 can include an online tip jar 7184 as well as bonuses from service providers for excellent ratings and feedback 7186. In some embodiments, production resource management module handles system integrity 7216 through blind orders 7202 as well as ratings and feedback 7214. Blind orders 7202 include blind orders to test timing 7194, blind orders to test quality 7196, blind orders to test shipping times 7198, and confirmation of standards for certifications 7200. Ratings and feedback 7186 can include ratings of makers 7204 as well as ratings of customers 7212 for payment history 7206, numbers of escrow complaints 7208 and numbers of returns 7210.

In some embodiments, constructing a tentative assignment of the order components to a plurality of production resources includes determining product availability 7220, which includes fixed timing 7222, dynamic throttling of order completion 7224, use of an algorithmic engine for timing minimization 7360, tools for providing reporting transparency to the consumer 7362, an algorithmic engine for optimized utilization 7364, and an algorithmic engine for smoothing revenues.

Dynamic throttling of order completion 7224 includes routing to and managing particular makers 7226 (e.g., production resources), handling outages 7298 (scheduled 7300 or unscheduled 7302), dealing with availability of completed sub-assemblies 7304 (scheduled 7306 or unscheduled 7308), addressing shipping constraints 7310 (scheduled 7312, unscheduled 7314, or based on shipping location 7316), algorithmic outsourcing of sub-assemblies 7324, handling of equipment 7342, and equipment maintenance 7350.

Dynamic throttling of order completion 7224 includes routing to and managing particular makers 7226 (e.g., production resources), which includes certifying makers 7246, addressing time constraints of makers 7228, and handling algorithmic calculations of manufacturing factors 7270. Addressing time constraints of makers 7228 includes dealing with loading of other work orders 7230 and whether they are on time 7232, delayed 7234, how ratings for particular makers are calculated 7236, and feedback on quality 7238. Addressing time constraints of makers 7228 includes dealing with maker availability 7240, whether scheduled 7242 or unscheduled 7244.

Certifying makers 7246 includes certification validation 7262 and handling of certification factors 7248. Certification factors 7248 can include work quality 7250, safety 7252, specific equipment usage 7254, specific product assemblies 7256, ratings, and feedback 7260. Certification validation includes the handling of portable certifications that enable a maker to use equipment in multiple facilities 7264, certification for insurance coverage 7266, and a database of certified makers 7268.

Algorithmic calculations of manufacturing factors 7270 includes managing and reporting percentages of manufacturing geography (e.g., made in USA 7276 or made in Texas 7278), managing and reporting percentages of manufacturing by minorities 7280 (e.g., women 7282, racial minorities 7284, disabled people 7286, veterans 7288, and felons 7290). Algorithmic calculations of manufacturing factors 7270 includes managing and reporting percentages of manufacturing materials 7292, such as sustainable materials 7296 or recycled materials 7294.

Dynamic throttling of order completion 7224 includes addressing shipping constraints 7310 (scheduled 7312, unscheduled 7314, or based on shipping location 7316), such as drop-shipping to a customer 7316 and shipping to a production resource management provider for fulfillment 7320.

Algorithmic outsourcing of sub-assemblies 7324 includes minimizing delays based on timing constraints 7326, material constraints 7328 or equipment constraints 7330. Managing equipment 7342 includes managing equipment scheduling constraints 7332 based on equipment utilization 7334 and equipment unavailability 7336, whether scheduled 7338 or unscheduled 7340. Managing equipment includes managing equipment 7342 includes certifying locations with equipment 7344, certification for insurance coverage 7346 and a database of certified locations 7348.

### Example System

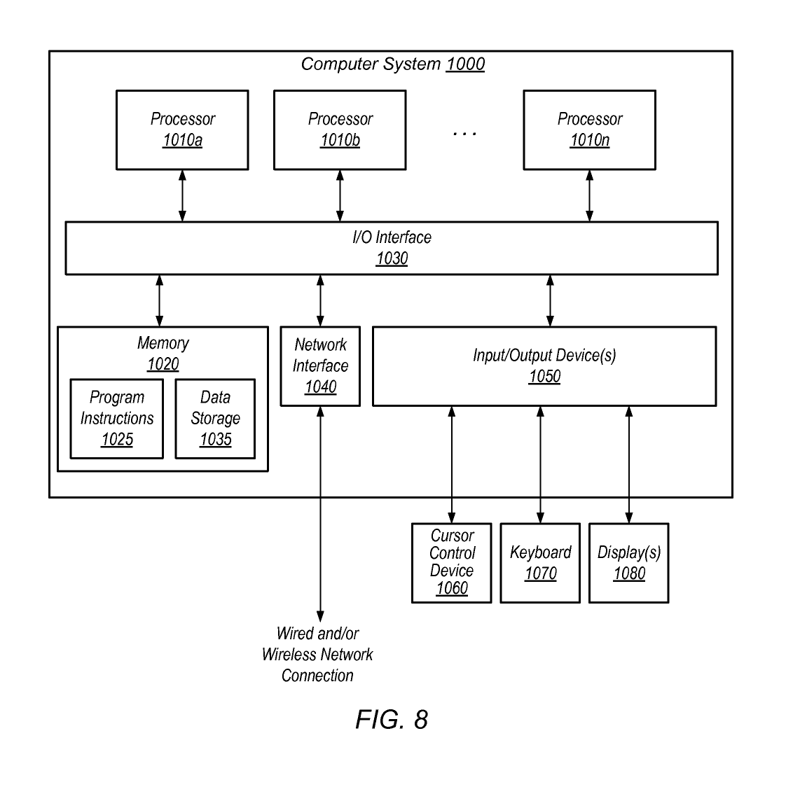

Embodiments of a production resource management module and/or of the production resources management techniques as described herein may be executed on one or more computer systems, which may interact with various other devices. One such computer system is illustrated by FIG. 8. In different embodiments, computer system 1000 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, and display(s) 1080. In some embodiments, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the image processing methods disclosed herein may, at least in part, be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies (AMD), and others.

System memory 1020 may be configured to store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above for embodiments of a production resource management module are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer-accessible medium may include storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network, such as other computer systems, or between nodes of computer system 1000. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1040.

As shown in FIG. 8, memory 1020 may include program instructions 1025, configured to implement embodiments of a production resource management module as described herein, and data storage 1035, comprising various data accessible by program instructions 1025. In one embodiment, program instructions 1025 may include software elements of embodiments of a production resource management module as illustrated in the above Figures. Data storage 1035 may include data that may be used in embodiments. In other embodiments, other or different software elements and data may be included.

Those skilled in the art will appreciate that computer system 1000 is merely illustrative and is not intended to limit the scope of a production resource management module as described herein. In particular, the computer system and devices may include any combination of hardware or software that can perform the indicated functions, including a computer, personal computer system, desktop computer, laptop, notebook, or netbook computer, mainframe computer system, handheld computer, workstation, network computer, a camera, a set top box, a mobile device, network device, internet appliance, PDA, wireless phones, pagers, a consumer device, video game console, handheld video game device, application server, storage device, a peripheral device such as a switch, modem, router, or in general any type of computing or electronic device. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent example embodiments of methods. The methods may be implemented in software, hardware, or a combination thereof The order of method may be changed, and various elements may be added, reordered, combined, omitted, modified, etc.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

What is claimed is:

1. A system for producing items using dynamically assigned production resources, the system comprising:
a processor; and
program instructions computer-executable to implement:
an order intake module configured to:
receive from a customer an item request,
communicate to the customer an estimate of a set of transaction satisfaction conditions derived from a tentative assignment of order components to a plurality of production resources, and
receive acceptance of the transaction satisfaction conditions; and
a production coordination module configured to:
responsive to the customer item request, deconstruct the item request from the customer into a plurality of order components,
construct a tentative assignment of the plurality of order components to the plurality of production resources, wherein
the tentative assignment further comprises:
for each of the plurality of order components, an identification of a task to be performed by a selected one of the plurality of production resources,
an accounting of any dependencies that exist between ones of the plurality of order components, and
expected scheduling of completion for each task, and
generate from the tentative assignment the transaction satisfaction conditions,
responsive to acceptance of the transaction satisfaction conditions, distribute the order components to the plurality of production resources.

2. The system of claim 1, wherein:
the production resources comprise automated manufacturing systems, and
the order components comprise automated instructions for causing the automated manufacturing systems to generate products or components of products through automated control.

3. The system of claim 1, wherein
the system further comprises a production resource reporting module configured to receive reports of statuses of the production resources, and
the order intake module is further configured to develop the estimate of the set of transaction satisfaction conditions reflecting reported levels of task availability at each of the respective production resources.

4. The system of claim 1, wherein
the system further comprises a production resource reporting module configured to receive reports of availabilities of inputs to the production resources, and
the order intake module is further configured to develop the estimate of the set of transaction satisfaction conditions reflecting reported levels of availabilities of inputs at each of the respective production resources.

5. The system of claim 1, wherein
the system further comprises a production resource reporting module configured to receive reports of statuses of the production resources, and
the order coordination module is further configured to construct a tentative assignment of the order components to the plurality of production resources based at least in part upon reported levels of task availability at each of the respective production resources.

6. The system of claim 1, wherein
the system further comprises a production resource reporting module configured to receive reports of performance of previous order components by the plurality of production resources, and
the order intake module is further configured to develop the estimate of the set of transaction satisfaction conditions reflecting performance of the previous order components by the plurality of production resources.

7. The system of claim 1, wherein
the system further comprises a production resource reporting module configured to receive reports of previous order components by the plurality of production resources, and
the order coordination module is further configured to construct a tentative assignment of the order components to the plurality of production resources based at least in part upon performance of previous order components by the plurality of production resources.

8. A method for coordinating production of an item by dynamically assigning production resources, the method comprising:
responsive to receiving from a customer an item request, deconstructing the item request from the customer into a plurality of order components;
constructing a tentative assignment of the order components to a plurality of production resources;
communicating to the customer an estimate of a set of transaction satisfaction conditions derived from the tentative assignment; and
responsive to acceptance of the transaction satisfaction conditions, distributing the order components to the plurality of production resources.

9. The method of claim 8, further comprising,
presenting to the customer an interface for
upon processing of the item request,
iteratively reviewing the transaction satisfaction conditions of the item request, and
allowing iterative modification of options associated with the item request;
responsive to the modification of the options associated with the item request,
constructing a revised tentative assignment of revised order components to a revised plurality of production resources, and
communicating to the customer a revised estimate of a set of revised transaction satisfaction conditions derived from the revised tentative assignment; and
responsive to acceptance of the revised estimate of the set of the revised transaction satisfaction conditions, distributing the revised order components to the revised plurality of production resources.

10. The method of claim 8, further comprising
for each order component of the plurality of order components, iteratively identifying for a set of item options a set of production resources capable of producing the order component, wherein the iteratively identifying further comprises
iteratively identifying a set of suborder components of the each order component of the plurality of order components, and
iteratively tentatively assigning production of the each suborder component to a suborder component production resource selected based at least in part on a set of production criteria related to production options selected for a respective order component associated with the suborder component, such that production of the set of suborder components satisfies criteria associated with the respective order component.

11. The method of claim 9, wherein
the tentative assignments comprise locks for excluding use of resources for a specified period, and
the constructing the revised tentative assignment of the order components to the revised plurality of production resources further comprises
releasing tentative assignments to production resources, and
making revised tentative assignments to a revised set of production resources.

12. The method of claim 8, wherein
the plurality of order components represents a plurality of components of the item to be produced by a respective ones of a plurality of production resources.

13. The method of claim 8, wherein
constructing a tentative assignment of the order components to a plurality of production resources further comprises developing a suborder component availability schedule reflecting reported levels of task availability at each of the respective production resources.

14. The method of claim 8, wherein
constructing a tentative assignment of the order components to a plurality of production resources further comprises developing a suborder component availability schedule reflecting resource pricing at each of the respective production resources.

15. A non-transitory computer-readable storage medium storing program instructions, wherein the program instructions are computer-executable to implement:
responsive to receiving from a customer an item request, deconstructing the item request from the customer into a plurality of order components;
constructing a tentative assignment of the order components to a plurality of production resources;
communicating to the customer an estimate of a set of transaction satisfaction conditions derived from the tentative assignment; and
responsive to acceptance of the transaction satisfaction conditions, distributing the order components to the plurality of production resources.

16. The non-transitory computer-readable storage medium of claim 15, further comprising:
program instructions computer-executable to implement presenting to the customer an interface for
upon processing of the item request,
iteratively reviewing the transaction satisfaction conditions of the item request, and
allowing iterative modification of options associated with the item request;
program instructions computer-executable to implement, responsive to the modification of the options associated with the item request,
constructing a revised tentative assignment of revised order components to a revised plurality of production resources, and
communicating to the customer a revised estimate of a set of revised transaction satisfaction conditions derived from the revised tentative assignment; and
program instructions computer-executable to implement, responsive to acceptance of the revised estimate of the set of the revised transaction satisfaction conditions, distributing the revised order components to the revised plurality of production resources.

17. The non-transitory computer-readable storage medium of claim 15, further comprising
program instructions computer-executable to implement, for each order component of the plurality of order components, iteratively identifying for a set of item options a set of production resources capable of producing the order component, wherein the program instructions computer-executable to implement iteratively identifying further comprises
program instructions computer-executable to implement iteratively identifying a set of suborder components of the each order component of the plurality of order components, and
program instructions computer-executable to implement iteratively tentatively assigning production of the each suborder component to a suborder component production resource selected based at least in part on a set of production criteria related to production options selected for a respective order component associated with the suborder component, such that production of the set of suborder components satisfies criteria associated with the respective order component.

18. The non-transitory computer-readable storage medium of claim 15, wherein
the tentative assignments comprise locks for excluding use of resources for a specified period, and
the program instructions computer-executable to implement constructing the revised tentative assignment of the order components to the revised plurality of production resources further comprise:
program instructions computer-executable to implement releasing tentative assignments to production resources, and
program instructions computer-executable to implement making revised tentative assignments to a revised set of production resources.

19. The non-transitory computer-readable storage medium of claim 15, wherein
the plurality of order components represents a plurality of components of the item to be produced by a respective ones of a plurality of production resources.

20. The non-transitory computer-readable storage medium of claim 15, wherein
the program instructions computer-executable to implement constructing a tentative assignment of the order components to a plurality of production resources further comprise:
program instructions computer-executable to implement developing a suborder component availability schedule reflecting reported levels of task availability at each of the respective production resources.
